(19) United States
(12) Patent Application Publication
(10) Pub. No.: US 2013/0109106 A1
(43) Pub. Date: May 2, 2013

(54) SYSTEM FOR SELECTIVELY PROCEEDING A SAMPLE

(71) Applicants: Derk Jan Wilfred Klunder, Eindhoven (NL); Jeroen Hans Nieuwehuis, Eindhoven (NL); Menno Willem Jose Prins, Eindhoven (NL); Toon Hendrik Evers, Eindhoven (NL)

(72) Inventors: Derk Jan Wilfred Klunder, Eindhoven (NL); Jeroen Hans Nieuwehuis, Eindhoven (NL); Menno Willem Jose Prins, Eindhoven (NL); Toon Hendrik Evers, Eindhoven (NL)

(73) Assignee: KONINKLIJKE PHILIPS ELECTRONICS N.V., Eindhoven (NL)

(21) Appl. No.: 13/808,522

(22) PCT Filed: Jul. 4, 2011
(86) PCT No.: PCT/IB2011/052935

§ 371 Date: Jan. 4, 2013

(30) Foreign Application Priority Data
Jul. 9, 2010 (EP) 10169056.8

(51) Int. Cl. G01N 1/10

(52) U.S. Cl. CPC G01N 1/10
USPC 436/180; 422/501

(57) ABSTRACT

The invention relates to a method and a system (100) for selectively processing a sample (130) according to one of a plurality of different assays, for example for detecting a certain target component in the sample. The system comprises a plurality of “specific reagent reservoirs” (120) that contain different sets of reagents, wherein each set is required for one of the assays. Moreover, the system (100) comprises a “universal reagent reservoir” in which reagents for several assays are provided, preferably reagents for all assays. The universal reagent reservoir may preferably be a cartridge (110) in which the processing of a sample (130) can take place and which comprises a plurality of binding sites that are selective for different target components. Depending on the assay to be performed with a sample (130) at hand, the appropriate specific reagent reservoir (121b) is chosen and processed in the universal cartridge (110). This can particularly be done by a manipulator (140) in a high-throughput automated laboratory system.

### FIELD OF THE INVENTION

The invention relates to a system and a method for processing a sample according to a selected one of a plurality of assays, particularly for detecting selected target components in a biological sample. Moreover, it relates to designs of a pipette-tip and a cartridge that can be used in such a system.

### BACKGROUND OF THE INVENTION

From the WO 2008/155716 A1 a biosensor is known in which target components labeled with magnetic beads are detected by frustrated total internal reflection (FTIR) at the sensing surface of a cartridge. The described biosensor is particularly designed and suited for point-of-care applications, for example roadside drug tests.

### SUMMARY OF THE INVENTION

Based on this background it was an object of the present invention to provide means that allow the processing of a sample in a stationary, high-throughput laboratory environment.

This object is achieved by a system according to claim 1, a method according to claim 2, a pipette-tip according to claim 12, an integrated pipette-tip according to claim 13, and a cartridge according to claim 14. Preferred embodiments are disclosed in the dependent claims.

According to a first aspect, the invention relates to a system for processing a sample according to a selected one of a plurality of assays, particularly immunoassays. The sample may typically be a biological fluid, for example saliva or blood. The assays comprise the instructions how a sample at hand shall be processed in order to achieve a desired result, wherein the processing may comprise any arbitrary steps, including the physical and/or chemical modification of the sample. The aim of the assays may for example be the detection of different target components in a sample, for example of drugs, antibodies, DNA, or the like. The processing steps of the assays will typically require the use of specific reagents. In view of this, the system comprises the following components:

a) A plurality of reagent reservoirs, called “specific reagent reservoirs” in the following, wherein said specific reagent reservoirs comprise different (individual) sets of reagents and wherein each of these sets is required for one (and preferably only one) of the assays. With other words, the reagents of one specific reagent reservoir are associated to one of the assays and are generally not suitable or needed for the other assays. It should be noted that a “set” of reagents may in the most simple case comprise just one reagent.

b) At least one further reagent reservoir, called “universal reagent reservoir” in the following, wherein said universal reagent reservoir comprises a plurality of reagents, each of these reagents being required in (at least) one assay. Moreover, at least two of the reagents shall be required in different assays (i.e. a first reagent is required in a first assay and a second reagent is required in a second assay, but the first reagent is not required in the second assay and vice versa). Hence reagents for different assays are combined into one and the same universal reagent reservoir.

Due to its universal reagent reservoir, the described system has the advantage that the number of different reservoirs that have to be kept on stock is reduced, which facilitates the demands of available space and simplifies the handling steps that have to be done. At the same time, the sensitivity of the approach is guaranteed by the use of specific reservoirs, which can be loaded with those reagents the combination of which would impair the outcome of the assays. It turns out that the combination of universal and specific reagent reservoirs is optimally suited for a use in a high-throughput centralized laboratory environment.

It should be noted that the specific reagent reservoirs and the universal reagent reservoir are usually present in a given system in many identical copies, such that a plurality of the same or of different assays can be performed with the system. In this sense, the terms “specific reagent reservoir” and “universal reagent reservoir” can be understood to denote a type, set, or category of components.

Most preferably, the universal reagent reservoir comprises reagents belonging to a certain category that is needed in all assays, for example the category of specific labels for a target molecule. Addition of the appropriate reagent from this category to a sample is then accomplished by simply joining the sample and the universal reagent reservoir.

According to a second aspect, the invention comprises a method for processing a sample according to a selected one of a plurality of assays, said method comprising the following steps:

a) Provision of a plurality of different “specific reagent reservoirs” that contain different sets of reagents which are required for one of the assays.

b) Provision of a “universal reagent reservoir” that contains a plurality of reagents for the assays, wherein at least two of these reagents are required in different assays.

c) Joining a sample with the reagents from a selected one of the aforementioned specific reagent reservoirs and/or from the universal reagent reservoir.

The method comprises in general form the steps that can be executed with a system of the kind described above. Reference is therefore made to the above description for more information about the details, advantages, and modifications of the method.

In the following, various preferred embodiments of the invention will be described that relate to both the system and the method of the kind described above.

It was already said that the system and the method are suited for a high-throughput environment. Preferably, they are adapted to perform more than 20 tests/hour, preferably more than 50 tests/hour, most preferably more than 150 tests/hour.

Furthermore, it is preferred that the system is accommodated in a housing. The universal reagent reservoirs and the specific reagent reservoirs are then stored inside the instrument, and it is not necessary to (manually) insert them with each test.

The cartridges used in the system or method may preferably have a foil-based design, i.e. they comprise at least one layer made from a flexible sheet (foil). Preferably, all the layers of the cartridge are made from foils.

The system or the method may preferably comprise a manipulator for automatically joining a sample with the reagents from a selected one of the specific reagent reservoirs and/or of the universal reagent reservoir, for example by introducing the sample into the reagent reservoir. The manipulator may for instance comprise a robot arm that can transfer components from one location to another. The manipulator may optionally be designed such that it can first mix a sample with reagent(s) from one of the reagent reservoirs before it introduces that mix into a reaction chamber.

In a further development of the aforementioned embodiment, several copies of the specific reagent reservoirs and of the universal reagent reservoir are arranged in the reach of the manipulator. Hence a system architecture can be achieved in which a plurality of samples can automatically be processed in series and/or in parallel. The system or the method may further preferably comprise a readout-device in which the sample can be processed, wherein said sample may for example be provided to the readout-device in a disposable cartridge. The readout-device may particularly be adapted to allow the detection of target components in a sample, wherein said detection may apply optical, electrical, magnetic, acoustic, radioactive or any other suitable measurement principles. For optical detection, the readout-device may for example comprise a light source for illuminating a sample in a cartridge and a light detector for measuring light emitted from the sample (particularly by an FTIR process).

The system or the method may also preferably comprise at least one actuation-device in which a sample comprised in a cartridge can be actuated, preferably by the action of electromagnetic fields and/or heat. The actuation-device may particularly comprise a magnetic field generator, for example a permanent magnet or an electromagnet. The inclusion of an actuation-device increases considerably the menu of assays that can be executed. The number of possible assays can even more be increased if several different actuation-devices are comprised by the system. Moreover, it is possible to provide several identical copies of an actuation-device so that a plurality of assays can be done in parallel.

In another embodiment of the invention, the mentioned readout-device and actuation-device are comprised by an integrated actuation-and-readout device. This reduces the handling steps to be done by the manipulator, because a sample (in a cartridge) can be delivered in one step to both an actuation and detection process.

Of course any combination of the above embodiments can be applied, yielding a general architecture with N readout-devices, M actuation-devices, and L actuation-readout-devices (N, M, L=0, 1, 2, . . . ).

Moreover, the at least one of the above mentioned readout-devices, actuation-devices, and/or actuation-and-readout devices may optionally be movable by the manipulator together with a cartridge. This allows to perform some actuation and/or detection even which a cartridge (with a sample) is transported. For example, if the actuation-device comprises a magnet, the exertion of magnetic forces on a sample can favorably be continued during the movement of a cartridge.

According to another preferred embodiment of the system and the method, the universal reagent reservoir is a cartridge in which the processing of a sample can take place. The term “cartridge” shall in this context denote an exchangeable element or unit that can accommodate a sample. The cartridge will usually be a disposable component which is used only once for a single sample. In this embodiment, the cartridge comprises already reagents required for the assay to be performed and simultaneously provides the physical environment for the processing.

According to a further development of the aforementioned embodiment, the reagents of the cartridge (universal reagent reservoir) comprise binding sites that are specific for different target components which may be present in a sample. As usual, the term “binding sites” shall denote reagents that are immobilized on a surface (of a cartridge) and that specifically bind to certain (usually labeled) target components, thus immobilizing these, too. In this embodiment, the binding sites that may be required in several (preferably all) of the possible assays are provided in one and the same cartridge. This has the advantage that only one type of such a cartridge is needed and that it is not necessary to produce this comparatively complex component in different versions. Moreover, the amount of reagent needed for binding sites is usually small, so that a possible waste of unused binding sites is no serious issue.

The aforementioned embodiment particularly provides a “generic disposable cartridge” that is for example made specific after the addition of labels (e.g. magnetic beads) for a specific assay. To make the cartridge “generic” in this sense, it should contain specific binding sites for each analyte on the menu, which could typically be more than about 40 different binding sites.

In a further development of the above embodiment, the unused binding sites that are not specific for the target component(s) present in a sample at hand are advantageously used for reference measurements. As no specific binding of target components takes place at the unused binding sites but only unspecific processes, measurement of the unused binding sites can provide valuable information about the background of an examination process. This information allows to increase the accuracy of the processing results.

Depending on the given sample and the intended assay, the reagents that are provided in the (specific and/or universal) reagent reservoirs may substantially comprise any arbitrary substance. In a preferred embodiment, the reagents of the reagent reservoirs, particularly of the specific reagent reservoirs, comprise label particles that selectively bind to one target component which may be present in a sample. In general, the term “label particle” shall denote a particle (atom, molecule, complex, nanoparticle, microparticle etc.) that has some property (e.g. optical density, magnetic susceptibility, electrical charge, fluorescence, radioactivity, etc.) which can be detected, thus indirectly revealing the presence of the associated target component. Typical examples of label particles are magnetic beads.

According to another embodiment of the system or the method, the sample to be processed is mixed with the set of reagents from one of the specific reagent reservoirs before it is introduced into a cartridge. In this way the incubation of the sample with the reagents can be executed under controlled conditions outside the cartridge.

According to a further development of the invention, at least one specific reagent reservoir is realized as a pipette-tip. As usual, the term “pipette” refers to a laboratory instrument used to take up (usually by suction) and transport a measured volume of liquid. The term “pipette-tip” as used here refers to the (typically exchangeable/disposable) tip or container that is used in combination with a suction device and that provides the cavity into which the liquid is taken up.

In another embodiment of the invention, at least one specific reagent reservoir may comprise a cartridge additionally to the storage space for the set of reagents of said reservoir. This integration of a cartridge has the advantage that, by selecting and taking the specific reagent reservoir for an assay, the appropriate processing environment (i.e. the cartridge) is simultaneously taken, too. Hence the handling is considerably facilitated.

The last two embodiments of the system and the method comprise designs which constitute separate, standalone aspects of the invention.

As a third aspect, the invention hence also comprises a pipette-tip that comprises at least one reagent attached to a surface which comes into contact with a sample drawn into the pipette-tip. With other words, the reagent is attached to an inner surface of the cavity into which the liquid is taken up. The reagent is typically provided in dry form.

The pipette-tip can particularly be used as a specific reagent reservoir in a system and method of the kind described above. Besides this, a pipette-tip pre-filled with reagent(s) can also be used in many other applications. It has the advantage that the usual uptake of liquid into the pipette-tip is combined with the incubation of said liquid with reagent(s). Moreover, processing accuracy can be improved as the pre-filling of the pipette-tip with reagent(s) is typically done with high precision during an industrial manufacturing process.

The reagent that is stored in the pipette-tip may particularly comprise at least one type of label particle that specifically binds to a target component, for example magnetic beads with specific binding molecules on their surface.

According to a fourth aspect, the invention relates to an integrated pipette-tip for a system or a method of the kind described above, said integrated pipette-tip comprising a sample container into which a liquid sample can be taken up and a cartridge in which processing of a sample can take place. The cartridge may particularly be designed to allow for optical examinations, for example by providing transparent components for light incoupling, guiding, and outcoupling.

In a particular embodiment, the integrated cartridge functions as a universal reagent reservoir, i.e. it comprises a plurality of reagents, wherein each of these reagents is required in (at least) one assay, but wherein at least one of the reagents is not required in all the assays. The cartridge may for example comprise a plurality of binding sites selective for different target components. If the cartridge comprises all reagents belonging to a certain category that is needed in all assays, the required number of different integrated pipette-tips is the same as the number of different specific reagent reservoirs (each specific reagent reservoirs is augmented by integration of the same type of cartridge). Hence the complexity of the system is not increased by the integration of specific reagent reservoirs and cartridge (universal reagent reservoir).

According to a further development of the integrated pipette-tip, a valve is provided that separates the sample container from the cartridge. This allows to control the transition of a sample from the sample container into the cartridge.

The cartridge that is used in the system, the method or the integrated pipette-tip described above may preferably have a sample chamber in which examinations can be made, particularly optical examinations. For the optical examinations, the whole cartridge or at least a part of the cartridge may be transparent, for example made from glass or transparent plastic. Moreover, the transparent part of the cartridge may be provided with suitable optical elements like prismatic or lens-like protrusions or embossings, gratings, polished surface areas etc. Most preferably, the cartridge is adapted to allow the examination of a sample in the sample chamber by frustrated total internal reflection (FTIR) of light emitted into the cartridge.

According to a fifth aspect, the invention relates to a cartridge which may be used in the above system, method or integrated pipette-tip and in other applications, too. Such a cartridge comprises the following components:

a) A sample chamber that is accessible from at its top side for adding a sample, for example by a pipette-tip. In particular, the sample chamber may be (completely) open at its top side.

b) Optical structures for the incoupling and outcoupling of light, wherein a sample in the sample chamber can be examined with said light. The optical structures may for example comprise prismatic or lens-like protrusions or embossings, gratings, polished surface areas etc.

Leaving the top side of the sample chamber accessible simplifies the production of the cartridge as no components like fluidic structures are needed and as chemicals like binding sites can more readily be applied to the (bottom) surface of the sample chamber. Moreover, the cartridge is more readily accessible for filling it with a sample and/or with reagents, and the filling is achieved quasi instantaneously (instead of slowly as if the fluid has to move along channels).

To protect the described cartridge against a possible contamination, particularly during times while it is on stock or transported, it is preferred that a lid is provided for closing the top side of the sample chamber, wherein the lid is designed such that it does not hamper the free accessibility of the sample chamber through the top side. To this end, the lid may for example be removable or readily destructible if access is required. The lid may optionally be attached to the cartridge, for example via a hinge, or it may be a separate (removable) component. A removable lid may optionally be reused many times (particularly if has some elaborate design), even if the associated cartridges are discarded. For this reason, the scope of the present application also extends to the lid as an article of its own, independent of the cartridge it shall be used with.

The aforementioned lid can be realized in the various ways. According to a first embodiment, the lid may for example comprise a magnet. A magnet is typically needed in assays using magnetic particles. Combining the functions of a lid and a magnet has the advantage that only one part is needed and that the magnet can come into close proximity to a sample in the sample chamber. Preferably, such a lid with a magnet constitutes a component that is reused as often as possible.

According to another embodiment, the lid comprises a slanted interior surface and an air vent, wherein said air vent is disposed at the highest position of the lid. When such a lid is placed on a cartridge in which the sample chamber is already filled with a liquid, no gases are trapped as they can leave the sample chamber through the air vent.

In another embodiment, the lid is realized by a pierceable foil. The foil may for instance be applied to the sample chamber during the production of the cartridge. Piercing of the foil can for example be readily done with a pipette.

In all the above embodiments of a lid, (dry) reagents may optionally be attached to said lid. If the lid is separate from the cartridge, selection and addition of reagents can hence be achieved by adding the appropriate lid (with reagents) to a cartridge.

The invention further relates to the use of a system, pipette-tip, integrated pipette-tip or cartridge of the kind described above for molecular diagnostics, biological sample analysis, chemical sample analysis, food analysis, and/or forensic analysis. Molecular diagnostics may for example be accomplished with the help of magnetic beads or fluorescent particles that are directly or indirectly attached to target molecules.

### BRIEF DESCRIPTION OF THE DRAWINGS

These and other aspects of the invention will be apparent from and elucidated with reference to the embodiment(s) described hereinafter. These embodiments will be described by way of example with the help of the accompanying drawings in which:

FIG. 1 schematically illustrates an automated system for the examination of samples according to the state of the art;

FIG. 2 schematically illustrates an automated system for the examination of samples using specific and universal reagent reservoirs according to the invention;

FIG. 3 schematically illustrates the uptake of a sample into a pipette-tip comprising a reagent;

FIG. 4 schematically illustrates the transfer of the sample from the pipette-tip of FIG. 3 into a cartridge;

FIG. 5 schematically illustrates the sequential uptake of reagents and sample into a pipette-tip;

FIG. 6 schematically shows an integrated pipette-tip comprising a sample container and a cartridge;

FIG. 7 shows a top view onto the cartridge of the integrated pipette-tip of FIG. 6;

FIG. 8 shows a section along line VIII-VIII of FIG. 7;

FIG. 9 schematically shows the filling of a cartridge with an open top side;

FIG. 10 schematically shows a cartridge with an open top side and a lid with an integrated magnet;

FIG. 11 shows a perspective view of a lid for a cartridge with an open top side;

FIG. 12 shows a section through the lid of FIG. 11;

FIG. 13 shows the lid of FIG. 11 on a cartridge;

FIG. 14 schematically shows a cartridge with an open top side and a further embodiment of a lid;

FIG. 15 schematically shows a cartridge with an open top side and a foil as a lid.

Like reference numbers or numbers differing by integer multiples of 100 refer in the Figures to identical or similar components.

### DESCRIPTION OF PREFERRED EMBODIMENTS

Biosensors based on nanoparticle labels, particularly nanoparticles that can be actuated with electromagnetic fields (“magnetic beads”), are for example know from the WO 2008/155716 A1. Typically, the magnetic beads are functionalized with antibodies that can bind a specific target molecule. The beads are attracted to the sensor surface, where the number of bound beads is directly or inversely related to the amount of target molecules present in the sample. The beads can then be detected using any technique that is more sensitive to beads that are close to the surface, e.g. frustrated total internal reflection (FTIR). Using this technique, the sensitivity to the nanoparticle labels decreases exponentially with an increasing distance from the surface. The described technology has been developed for point-of-care (POC) applications.

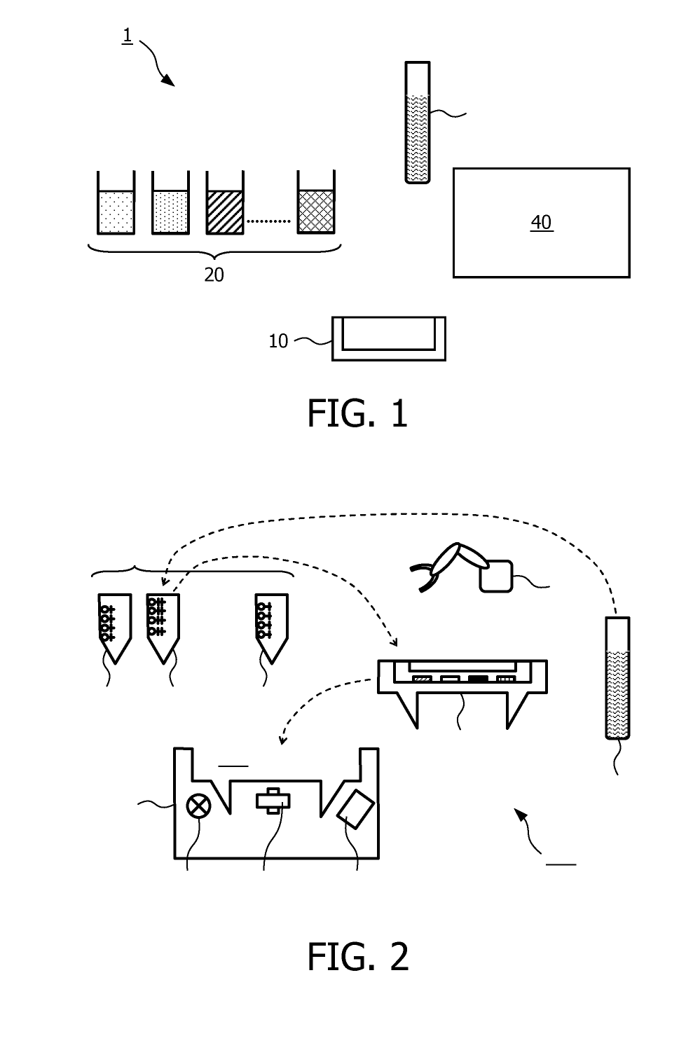

In contrast to this, the majority of immunoassay testing is carried out in central laboratories, where large instruments are used. FIG. 1 schematically illustrates such a laboratory system 1 for the execution of different assays with a sample 30 (typically plasma or serum). The system is based on the so-called random access concept and comprises a manipulator 40, which is controlled by a computer with appropriate software (not shown). The manipulator 40 can take a sample to be investigated and transfer it to an open reaction vessel 10. Moreover, the robot has access to a supply 20 of different wet reagents. Depending on the assay to be performed, the robot can take the required reagents one by one from this supply 20 and add them to the reaction vessel 10. By various pipetting and incubation steps the complete assay is carried out. Finally the reaction vessel 10 is transferred to a detection device (not shown) to quantify the outcome of the assay.

The essence of such a system 1 is that a number of robotized sample and reagent handling steps of an assay is executed in an empty reaction vessel 10 that can be used for any test, where the specific reagents that determine the type of test are added later.

Although the described robotized system concept is quite flexible and can handle many samples per hour, there are some drawbacks:
The use of robotics is an expensive solution, resulting high instrument cost.
To accommodate all the robotized handling, the instruments are quite large, occupying expensive floor-space in the laboratory.
The volumes of (wet) reagents used are typically quite high resulting in high waste disposal costs (both the servicing aspect of the instrument as well as the actual disposal of the biological waste).

It is therefore desirable to provide a system that allows a simplified yet accurate execution of a plurality of different assays with a sample.

A solution to this problem will be explained with reference to the Figures. This solution is based on the following principles:

1. Having a single “universal reagent reservoir” with reagents for all/most of the assays of the menu.

2. Further reagents specific for a certain assay are stored in “specific reagent reservoirs” which can selectively be accessed.

In the following description of an exemplary embodiment, the universal reagent reservoir will be a “universal cartridge” comprising binding spots for all/most of the target components that shall be detected in the samples to be processed. Moreover, the reagents in the “specific reagent reservoirs” will be magnetic beads specific for a certain target component.

This proposed solution makes the POC-approaches compatible with architecture of random-access equipment. Since the amount of binding sites (antibody) used in the binding spots on the universal cartridge is up to two orders of magnitude smaller than the amount of antibody that used in typical random access systems, still significantly less reagent is used by the proposed solution even when binding spots for all target components are present.

FIG. 2 schematically illustrates a system 100 that is designed according to the above approach. The system 100 comprises the following components, which will be described in more detail below:
A (universal) cartridge 110 in which a sample at hand can be processed, for example be examined for the presence and/or amount of certain target components.
A supply 120 with a plurality of different specific reagent reservoirs 121a, . . . 121d.
A container 130 providing a sample fluid, for example a body fluid like blood or saliva.
A manipulator or robot arm 140 that can reach all the depicted components and manipulate them according to the desired processing steps.
A readout-device 150 in which the cartridge 110 with a sample can be processed.

The cartridge 110, which is shown in more detail in FIG. 4, can be identical or similar in design to cartridges known from for example the WO 2008/155716 A1. It typically consists of a transparent material 111 like glass or preferably plastics which allows its production by injection moulding. The cartridge 110 comprises an inlet 112 leading to a sample chamber 113, which is connected to an outlet 114. On the bottom side of the cartridge 110, prismatic protrusions 116a, 116b may be provided with windows that allow a well-defined entrance and exit of light beams.

The cartridge 110 comprises binding sites, arranged in a plurality of different binding spots 115a-115d on the bottom surface of the sample chamber 113. Each binding spot comprises typically only binding sites of one type, which are specific to only one target component. The whole set of binding spots shall however comprise binding sites for all the possible target components that may occur and shall be detected by the assays to be performed with the system 100. Hence the cartridge 110 is a general-purpose or “universal” cartridge comprising binding spots with capture probes for all target components on the menu.

The specific reagent reservoirs 121a, 121b, . . . 121d contain different reagents which are required for the processing of different target components. As indicated in FIG. 2, it is preferred that the reservoirs are designed as pipette-tips (i.e. the disposable tip of a pipette instrument). Alternatively the specific reagent reservoirs could be general containers as those shown in FIG. 1.

The readout-device 150 is designed according to the assays and processing steps that shall be executed with a sample in the cartridge 110. In the example of FIG. 2, it is assumed that the desired processing of the sample is the optical detection of certain target components, or, more specifically, the detection of target components labeled with magnetic particles (beads) and specifically bound to the binding sites in a corresponding binding spot on the bottom surface of the sample chamber. To this end, the readout-device 150 comprises a light source 152 for emitting an input light beam into the cartridge 110 when the latter is arranged in the corresponding seat 151 of the readout-device. Moreover, the device comprises a light detector 154, for example a photodiode or an image sensor, for the detection of an output light beam leaving the cartridge, wherein the output light is generated by (frustrated) total internal reflection of the input light beam at the bottom surface of the sample chamber 113. The details of this FTIR detection principle may for example be found in the WO 2008/155716 A1.

The readout-device 150 further comprises a magnetic field generator 153 for generating a magnetic field with which magnetic particles can be actuated. This allows for example to accelerate binding processes and/or to wash unbound magnetic particles away from the detection zone.

The processing of a given sample 130 with the system 100 according to a selected assay begins with the incubation of the sample with reagents from the appropriate specific reagent reservoir, for example reservoir 121b.

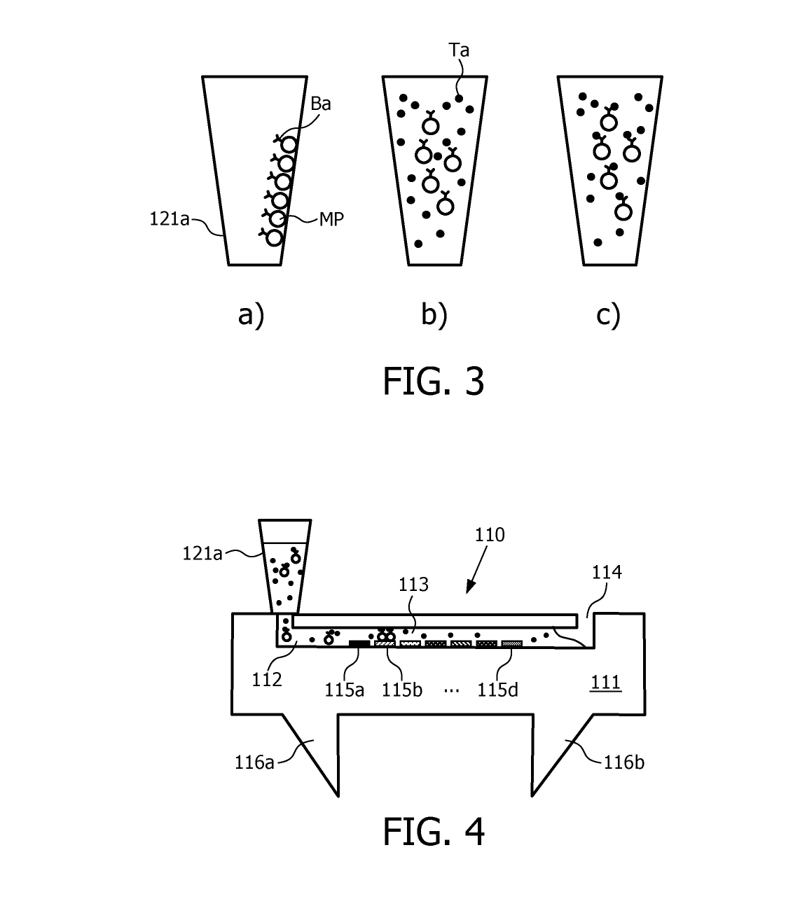

This is illustrated in more detail in FIG. 3 for the case that the specific reagent reservoirs consist of pipette-tips pre-filled with dry reagents. In particular, FIG. 3a shows the initial pipette-tip 121a, in which the interior surface of the sample container is covered with magnetic particles MP that are coated with binding molecules Ba specific for a certain target component (Ta). The binding molecules Ba may for example be antibodies.

FIG. 3b shows the pipette-tip 121a shortly after a sample fluid comprising the target components Ta has been taken up into the sample container. The magnetic particles MP are dissolved in the sample fluid.

FIG. 3c shows the situation after some time (typically minutes) of incubation. Now the target components Ta have specifically bound to the binding molecules Ba of the magnetic particles MP. It should be noted that typically only a small fraction of the magnetic particles is loaded with molecules depending on the concentration of target molecules in the sample.

FIG. 4 shows the next step, in which the solution with target-loaded beads is pipetted into the cartridge 110 and the beads loaded with targets can bind to a binding spot 115b with capture probes for that target component. During the detection step, the binding of the magnetic beads to this spot 115b can be detected both qualitatively and quantitatively. During this detection, one or more of the unused binding spots 150a etc. can favorably be used as a negative control, yielding information about the measurement background.

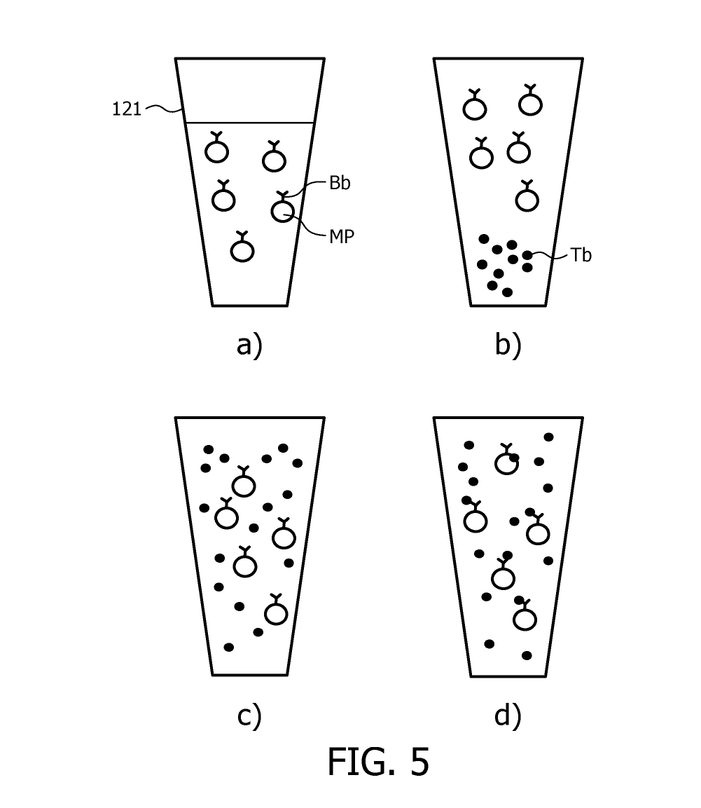

FIG. 5 illustrates an alternative procedure in which a standard pipette-tip 121 is used to take up the magnetic particles and the sample. FIG. 5a shows the first step, in which the standard pipette-tip 121 takes up the magnetic particles MP that are coated with binding molecules Bb and dissolved in a buffer.

FIG. 5b shows the next step, in which the sample fluid with the target components Tb has additionally been taken up by the pipette-tip.

In FIG. 5c, the additionally required step of mixing magnetic particles MP and target components Tb is shown.

FIG. 5d shows the situation after some time (typically minutes) of waiting, during which the target components bind to the binding molecules of the magnetic particles. After this step, the solution with target-loaded beads can be pipetted into the cartridge 110 as shown in FIG. 4.

With respect to the procedure of FIG. 3 (using dry beads), the procedure of FIG. 5 has the advantage that a general purpose pipette-tip can be used. Moreover, there are less stringent requirements for storage of pipette-tips as there are no dry beads in the pipette-tip.

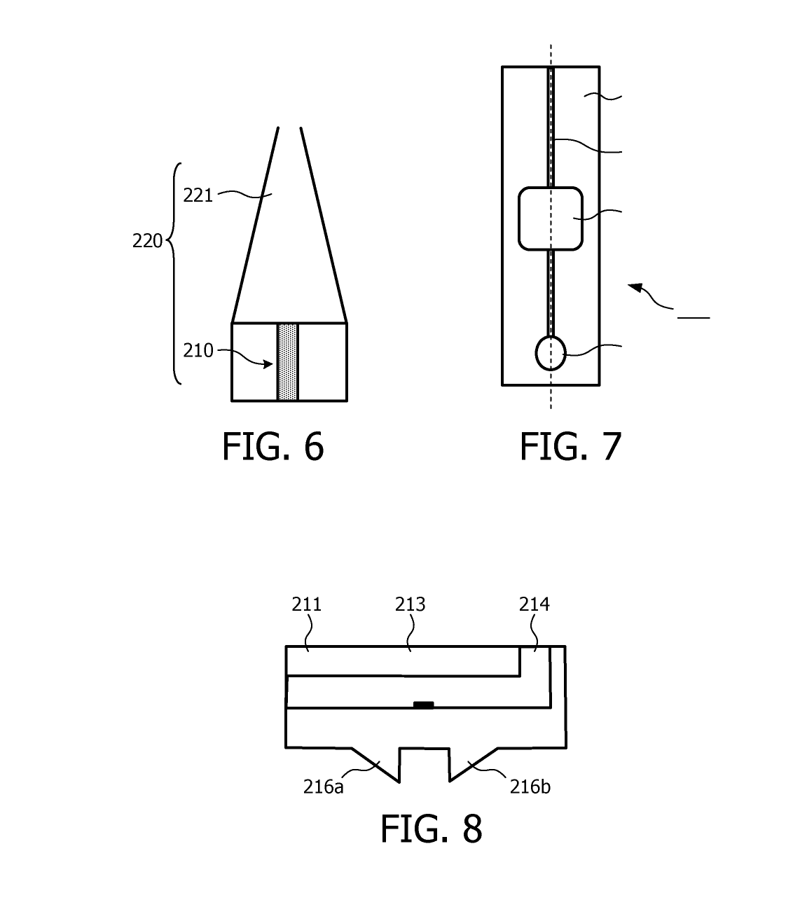

FIGS. 6 to 8 show an integrated pipette-tip 220 that may (inter alia) be used as specific and/or universal reagent reservoir in the system shown in FIG. 2. The integrated pipette-tip 220 comprises two main components, namely:
A sample container 221 for taking up a sample. This sample container may enable using larger sample volumes and mixing of reagents (e.g., adding the buffer with beads to the sample).
A support structure comprising a cartridge 210 in which sample that is drawn into the sample container 221 can be processed.

As FIGS. 7 and 8 illustrate in more detail, the cartridge 210 can be an FTIR-compatible cartridge of the kind described above, comprising:
a transparent body 211;
a microfluidic channel 212 for transporting (by means of capillary forces) a sample towards a sample chamber 213;
said sample chamber 213, the bottom of which is coated with a plurality of binding spots;
a fluid outlet 214;
an optical bottom part, including prisms 216a, 216b;
optionally, a valve (not shown) provided between the sample container 121 and the cartridge 210.

In a high throughput system, one typically uses larger sample volumes. This can be done with the described integrated pipette-tip 220. The larger volumes may be utilized to increase the sensitivity as follows:
Use lower concentration of beads.
Use a magnetic configuration to concentrate the beads near the entrance of the FTIR cartridge.
Open a valve to allow the beads to enter the cartridge; now the concentration of beads is similar to the concentration of beads in a conventional assays, but a larger volume was probed and depletion effects due to the presence of neighboring beads are avoided.

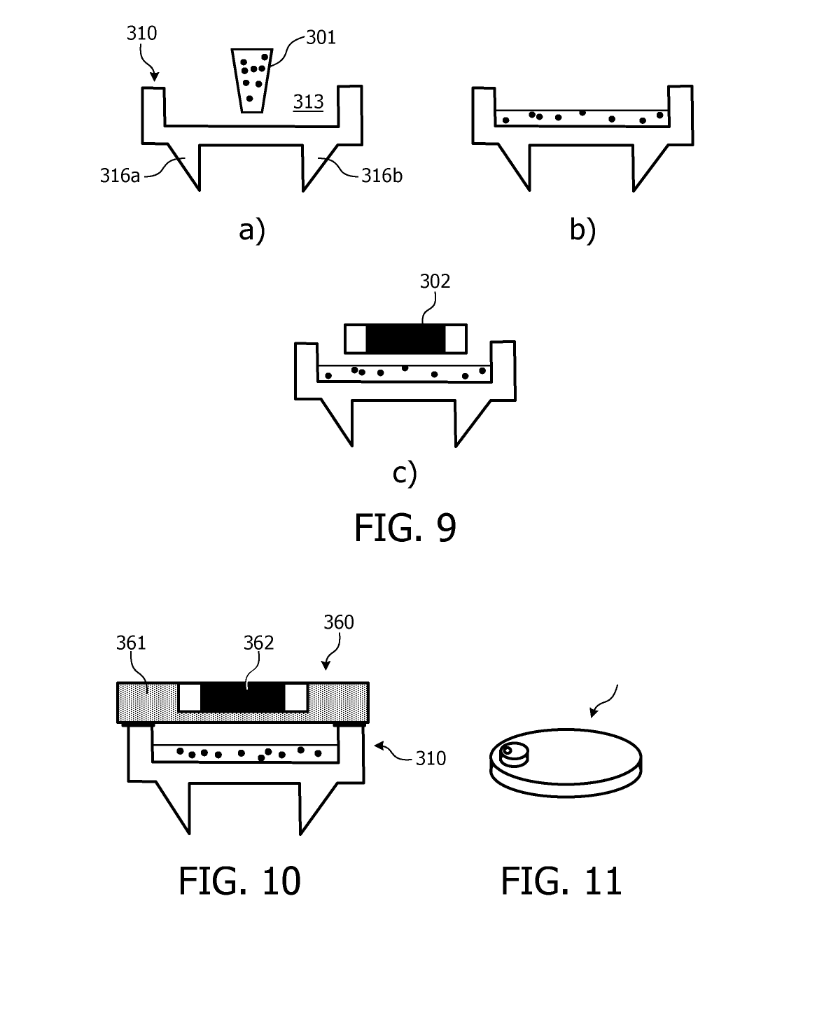

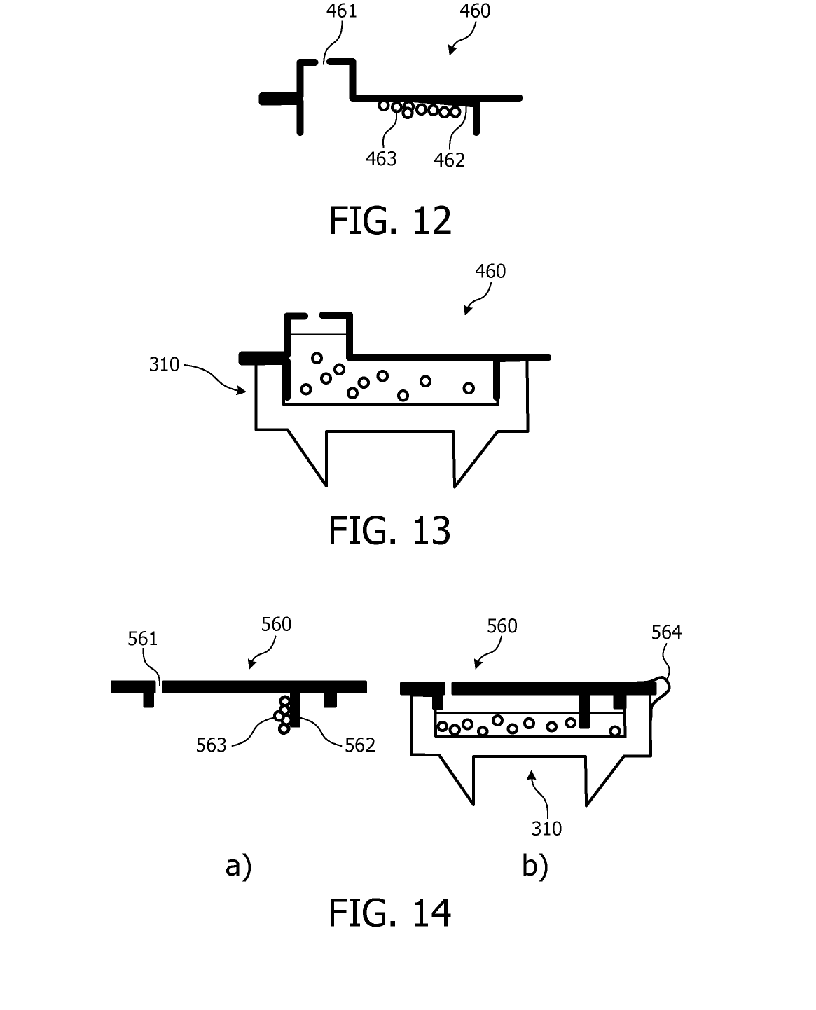

In the following, a particular cartridge design will be described with respect to FIGS. 9 to 15. The disclosed “open cartridges” can be used in any application that requires the use of a cartridge. In particular, they can be used in the systems described above, i.e. in a high throughput setting. The cartridges are in general characterized in that they comprise
a sample chamber that is accessible from the top;
optical structures for incoupling and outcoupling of light with which a sample in the sample chamber can be examined (e.g. by FTIR).

An “open cartridge” 310 of this kind is schematically shown in FIG. 9. It comprises a sample chamber 313 that is accessible from the top, as it is completely open to the top. On its bottom side, the cartridge 310 comprises two prismatic structures 316a, 316b through which light can be coupled in and out. The cartridge 310 can for example be produced as one piece by injection molding.

FIG. 9a shows particularly the addition of a sample with label particles comprised in a pipette-tip 301 to the cartridge. FIG. 9b shows the resulting thin layer of fluid in the open cartridge 310. FIG. 9c shows the positioning of magnets (only top magnet 302 is shown) to perform a magnetic assay. A possible contamination of the top coil 302 with the sample (although small amounts of liquid are not easily displaced) could be solved by closing the cartridge with a simple foil or cap after the liquid has been added.

The open cartridge provides the following advantages:
There is no need to assemble a second part of the cartridge, resulting in a simpler, cheaper cartridge. The binding spots at the bottom of the sample chamber can simply be printed on the injection molded part and can be stored in a dry condition.
There is also no need for small and complicated fluidic structures in the cartridge that are necessary for capillary filling, anti-bubble formation, fluidic stops etc., further simplifying the cartridge.
As there is no need for separate fluid in- and outlets, the total area of the cartridge is decreased, making it more easy to perform multiple assays on a small area.

The separate addition of particles and sample in two separate pipette steps is possible, which is not the case with a closed cartridge.

FIG. 10 shows how the cartridge 310 can be (reversibly) closed by a first cap or lid 360. The lid 360 consists of a carrier material 361 in which a magnet 362 is embedded. Instead of positioning a separate magnet above the open cartridge as shown in FIG. 9c, the lid 360 with the integrated magnet can be put upon the sample chamber. This has the advantage that the cartridge 310 is closed to prevent evaporation during the measurement. In this configuration, the lid 360 is part of the measurement device and is reused for each measurement. O-rings 363 (e.g. rubber) can optionally be used to effectively close the cartridge to prevent evaporation.

The closing of the cartridge as described above also offers the possibility of adding dry reagents (e.g. magnetic beads) to the lid. In this case the lid is typically a disposable. Because the dry reagents need to come in contact with the sample liquid, it is preferred that the entire sample chamber 313 is filled when applying the lid.

FIGS. 11 to 13 show a corresponding embodiment of a lid 460 with which the cartridge 310 can temporarily be closed. The lid 460 comprises dry reagents 463 on its interior surface 462. To prevent sample leaking out of the cartridge, an overflow chamber with air vent 461 is incorporated in the lid. To prevent air bubble enclosure, it is preferred that the interior surface 462 of the cap, facing the liquid, is slanted.

FIG. 14 shows a different approach to bring reagents 563 in contact with the liquid in the sample chamber 313 without the need to fill the entire chamber. This is possible with a lid 560 comprising a protrusion 562 that extends into the liquid and onto which the reagents 563 are applied. An air vent 561 is provided to allow the escape of trapped gases. Moreover, the Figure indicates a hinge 564 (for example a film hinge) with which the lid 560 is attached to the cartridge 310.

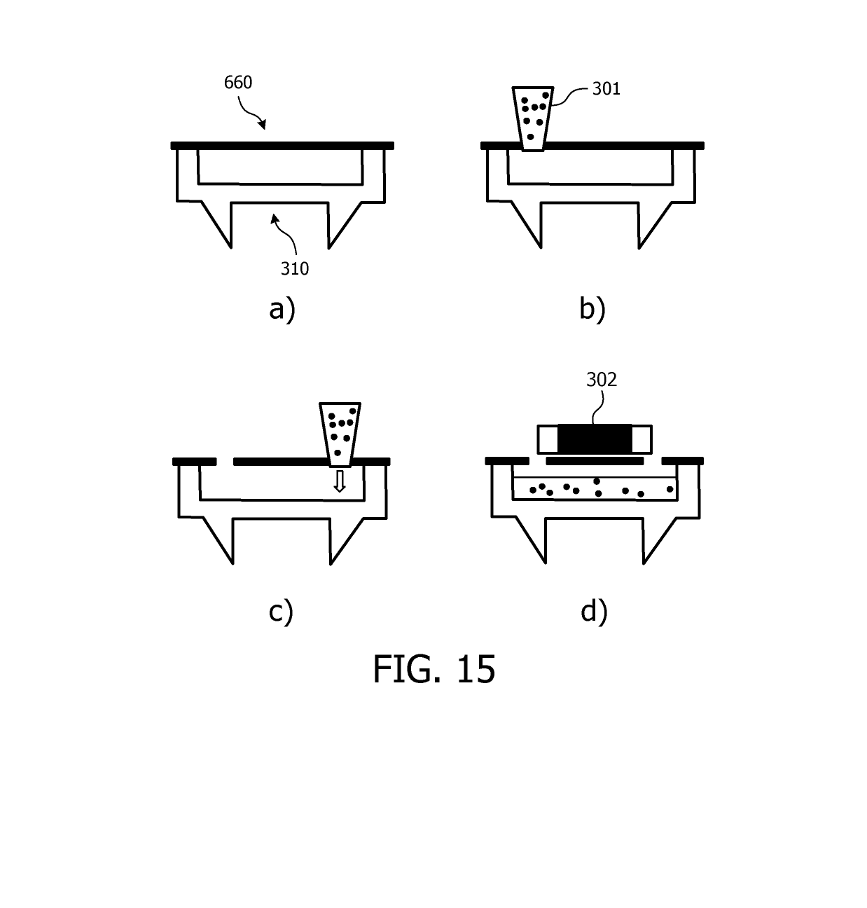

As shown in FIG. 15, the problem of contamination described above can be circumvented by closing the cartridge 310 with a foil 660 during manufacturing. Such a foil 660 has the additional advantage that it protects the sample chamber 313 from any external influences (dirt, moisture, physical contact etc.) during storage. The fluid can be added to the chamber 313 by pinching the foil 660 with a pipette-tip 301. To allow the enclosed air to flow out, the foil can be pierced with the pipette-tip twice, only releasing the fluid after the second time (cf. FIGS. 15b, 15c). FIG. 15d shows the positioning of magnets (only top magnet 302 is shown) to perform the magnetic assay.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A system for processing a sample according to a selected one of a plurality of assays, said system comprising
a) a plurality of “specific reagent reservoirs” that contain different sets of reagents, wherein each set is required for one of the assays;
b) a “universal reagent reservoir” that contains a plurality of reagents for the assays, wherein at least two of these reagents are required in different assays
c) an actuation-device or an integrated actuation-and-readout device comprising a magnetic field generator;
d) a manipulator for joining a sample with the reagents from a selected one of the specific reagent reservoirs and/or of the universal reagent reservoir;
wherein the universal reagent reservoir is a cartridge in which the processing of a sample can take place,
wherein the reagents of the cartridge comprise binding sites that are specific for different target components (Ta, Tb), and
wherein the reagents of the specific reagent reservoirs comprise magnetic particles (MP, Ba, Bb) that selectively bind to one target component (Ta, Tb).

2. A method for processing a sample according to a selected one of a plurality of assays with a system according to claim 1, said method comprising the following steps:
a) provision of a plurality of specific reagent reservoirs that contain different sets of reagents, wherein each set is required for one of the assays;
b) provision of a “universal reagent reservoir” that contains a plurality of reagents for the assays, wherein at least two of these reagents are required in different assays;
c) joining a sample with the reagents from a selected one of the specific reagent reservoirs and/or from the universal reagent reservoir.

3. (canceled)

4. The system or the method according to claim 1,
characterized in that several copies of the specific reagent reservoirs and of the universal reagent reservoir are arranged in the reach of the manipulator.

5. The system according to claim 1,
characterized in that there is at least one readout-device in which a sample can be processed, at least one actuation-device in which a sample comprised in a cartridge can be actuated, preferably by the action of electromagnetic fields and/or heat, and/or at least one integrated actuation-and-readout device.

6. (canceled)

7. (canceled)

8. The system or the method according to claim 1,
characterized in that the binding sites that are not specific for the target components present a given sample are used for reference measurements.

9. The system according to claim 1, characterized in that the reagents of the specific reagent reservoirs comprise label particles, that selectively bind to one target component (Ta, Tb).

10. (canceled)

11. (canceled)

12. (canceled)

13. (canceled)

14. The system according to claim 1,
characterized in that the cartridge has a sample chamber that is accessible from the top and that the cartridge comprises optical structures for the incoupling and outcoupling of light with which a sample in the sample chamber can be examined.

15. The system or the method according to claim 14,
characterized in that the cartridge comprises a lid for closing the top side of the sample chamber, wherein said lid preferably comprises at least one of the following elements: a magnet, a slanted interior surface and an air vent, reagents, and/or a pierceable foil.

16. A system for processing a sample according to a selected one of a plurality of assays, said system comprising
a) a plurality of “specific reagent reservoirs” that contain different sets of reagents wherein each set is required for one of the assays;
b) a “universal reagent reservoir” that contains a plurality of reagents for the assays, wherein at least two of these reagents are required in different assays; wherein at least one of the specific reagent reservoirs is a pipette-tip.
